(19) United States
(12) Patent Application Publication
(10) Pub. No.: US 2006/0162201 A1
(43) Pub. Date: Jul. 27, 2006

(54) Large surface advertising device for posters and method for controlling the poster exchange

(76) Inventors: Lutz Brahmig, Dresden (DE); Sebastian Ebert, Grossohrsdorf (DE)

Correspondence Address: WILLIAM COLLARD;COLLARD & ROE, P.C., 1077 NORTHERN BOULEVARD, ROSLYN, NY, 11576, US

(21) Appl. No.: 10/529,505

(22) PCT Filed: Sep. 25, 2003
(86) PCT No.: PCT/DE03/03192

§ 371 Date: Oct. 11, 2005

(51) Int. Cl. G09F 11/18

(52) U.S. Cl. 40/514; 40/515

(57) ABSTRACT

The invention relates to a large surface advertising device for posters and a corresponding method for controlling the poster exchange. The aim of the invention is to achieve an advertisement device which permits the installation of significantly larger advertising devices and operation over a long period of time with alternating adverts. The method shall permit a frequent poster change with short cycle times. According to the invention, the large surface advertising device for posters comprises a housing, housing chassis and base frame (6), with winding shafts (1 and (2) arranged thereon for accommodating web-like rollable posters. The poster web is moved between both said rollers (1) and (2), by means of winding on and off to change posters. At least one diverting device (3 and 4) is arranged at the top and bottom, before the upper winding shaft (1) and the lower winding shaft (2), on the housing chassis and the base frame (6). The guides for the posters permit winding of the poster web either on winding shaft (1) or (2) without the formation of creases. The controller maintains a free-hanging poster loop on the lower diverting device, independent of the winding direction.

The invention relates to a large-surface advertising device for posters and a related method for controlling the poster change for posters in advertising devices having a housing, particularly poster change devices for alternating advertising, whereby the housing is provided with a transparent viewing pane, and light sources are disposed behind or in front of the poster, whereby the posters can be made of different materials such as paper, film, textiles, fabrics, etc., and their combinations, and can also be made of multi-layer materials.

Advertising devices up to a certain size are known. Such advertising devices having a housing, often also referred to as poster changers, can be found in various locations. However, their size is limited by various factors. At present, such advertising displays are generally used only for poster sizes up to a width of 3 to 4 meters, namely for posters referred to as 18/1. Such advertising devices are too small to be used in the open landscape, because it is often not possible to set the displays up so close to the consumers of the advertising message, e.g. drivers, so that the advertising message can be sufficiently recognized. Therefore it is necessary to create larger and larger advertising devices.

At an earlier point in time, the size of the advertising device was limited solely by the tensile strength of the poster material. Since nowadays, the tensile strength even of larger posters can be guaranteed, whether they are based on paper or on plastic materials, the size is limited by the mechanical structure of the poster changers and the technology for rolling up and unrolling large posters. Thus it is usual to wind the individual posters, strung together as a type of poster web, onto the upper or lower rollers, and to display the posters in the viewing area in defined time intervals, by means of corresponding rotational movements. However, these rotating rollers must be configured to be very rigid, since even slight bending will result in the formation of wrinkles when the posters are rolled up. For one thing, the formation of wrinkles is disturbing to the observer, and for another, the formation of wrinkles results in destruction of the poster(s) that are strung together with one another, when they are rolled up and unrolled multiple times. Since the time during which a picture is to be shown is relatively short, i.e. it should amount to only a few seconds, a frequent poster change over a period of up to one month is required, during which the posters are displayed until they are changed. Therefore, very great demands are made both on the poster material and on the corresponding construction and the poster changing procedure, in order to allow the long standing times and continuous operation of the poster changer without disruptions. Such large posters possess a high cost factor, so that an aim is to produce the posters and to be able to handle them as inexpensively as possible. The most cost-effective solution even for large-surface posters having a width up to 12 meters is materials based on papers. The rollers onto and from which the posters that are strung together are to be rolled up and unrolled are put into rotational movement by way of special drives. In order to prevent the undesirable formation of wrinkles, i.e. in order to prevent the roller from bending, these rollers are preferably made of steel and are provided with a large diameter. However, there are limits to this technology, since the rollers cannot be made to have an unlimited length, in view of the fact that they bend. The diameter of the rollers is furthermore not allowed to be too big, so that the entire construction, including the weatherproof housing, does not become too gigantic and the rollers do not become too heavy. Being able to rotate the gigantic rollers in targeted manner and to position them in one position furthermore requires a much greater expenditure of energy than is normally required. In addition, so-called counter-rollers are disposed in the center of the rollers, which are supposed to press the poster down and prevent bending. However, since these counter-rollers must adapt to the constantly changing diameter of the rollers (rolled off—small diameter, several posters rolled up—larger diameter), a complicated additional control of these counter-rollers is necessary, and this makes the advertising device even more expensive. Furthermore, handling when replacing the posters is made more difficult, and this can hardly be done without a crane.

A large-surface advertising display case is described in DE 19959 363 A1, which is supposed to allow advertising with poster sizes up to a width of 12 meters. In this connection, the rollers onto which these large posters are supposed to be rolled up consist of carbon fiber material. The advantage of the carbon fiber rollers consists in a very low weight as compared with steel rollers, and the very great rigidity of the material with reference to the length of the roller. However, the technical solution described here has the disadvantage that rollers made of carbon fiber materials are very, very expensive.

A poster changer equipped in this manner therefore barely pays for itself or does not pay for itself at all, in terms of economics. Another disadvantage that must be considered is that in the case of the carbon fiber rollers, an upper and lower counter-roller are required, which in turn require complicated additional control.

In DE 100 04 566 A1, a poster hanging device is described that is no longer completely enclosed in a housing, i.e. the protective front pane in front of the poster is no longer necessary. In the case of large poster hanging devices, having a width up to 4 meters, the poster is therefore fully exposed to the prevailing weather conditions, in each instance. The biggest problem, however, is the different wind loads that prevail, which result in significant problems both with regard to stable behavior of the poster (not fluttering while the rollers are at rest) and, in particular, during poster changes (when the posters are rolled up or unrolled). The poster, i.e. the poster web is disposed between two roller disposed on top of one another. It is moved in the transport direction under a defined longitudinal tension. In order to be able to absorb the corresponding wind loads, holding means for permanently spreading the poster web are disposed on the lateral longitudinal edges, in the vertical direction, in the region between the upper and lower roller, according to this technical solution. In this connection, the tensile forces crosswise to the transport direction are supposed to be by means of various technical means, such as so-called piping (elastic edge reinforcements), non-positive-lock fixation by means of clamping rollers that run along (rollers that press against one another or against a slide table), positive-lock holding means (needle strips, needle wheels, or other grippers having a positive lock), so-called helical spreaders (in the case of textile poster webs, made from spreaders used in the textile industry) and, finally, of concurrent chains having tenter clips such as those used in the textile industry, for example. This solution as described has the disadvantage that only one solution of spreading devices can be used per poster change device, in each instance, for example, and these are then suitable only for a single embodiment of the poster web. Different poster materials can therefore not be used for such a large-surface advertising device. This type of embodiment is furthermore very complicated with regard to the additional holding means in the crosswise direction. Furthermore, the holding means must run along with the drive of the rollers that move the poster, in the crosswise direction. This system is furthermore very susceptible to breakdown and requires a lot of maintenance. It is questionable whether a poster change can take place at all at high wind loads, without damage to the poster.

It is the task of the invention to create a large-surface advertising device for posters, which makes it possible to be able to inexpensively set up significantly larger advertising devices and operate them over a long period of time, with alternating advertising messages, and to develop a method for controlling the poster change, which allows a frequent poster change (roll-up and unrolling procedure) and thereby short cycle times for the individual picture messages, and long operation without disruptions, for the posters that are strung together.

The task of the invention is accomplished, according to the invention, by means of the characteristics of the first two claims. The large-surface advertising device for posters consists of a housing, whereby a housing mount and base frame 6 is disposed in its interior, in which supply rollers (winding shafts) to accommodate rollable posters in web form are mounted and disposed. In the case of the poster changing device according to the invention, for alternating advertising, the housing is provided with a transparent viewing pane when set up outdoors. In the housing interior, light sources to illuminate the poster that is visible, in each instance, are disposed behind or in front of the poster. The poster web ends, in each instance, are releasably connected with the upper winding shaft 1 and the lower winding shaft 2, with a positive lock. The poster web is moved between these two winding shafts 1 and 2 by means of rolling it up or unrolling it, in order to change posters. At least one upper and lower deflection device 3 and 4 are disposed on the housing mount and base frame 6, at the top and bottom, in each instance, in front of the upper winding shaft 1 and the lower winding shaft 2. The poster web is guided by way of this upper deflection device 3 and lower deflection device 4. This guidance has the result that the poster web can be wound up either onto the upper winding shaft 1 or onto the lower winding shaft 2, without forming wrinkles, when it is wound up, in each instance. This compensates for the bending of the winding shafts 1 and 2.

According to the invention, in this connection the control of the poster change takes place by means of control of the winding shafts 1 and 2, in that the speeds of rotation of the winding shafts 1 and 2 are controlled by way of the drive and control unit 7, as a function of their current diameter during the winding process. Because of the posters that are strung together, as a result of their number, the diameter of the poster web rolled up on the winding shafts 1 and 2 can vary by several centimeters per winding process, as a function of the poster material and the basic diameter of the shafts. As a function of this, control of the upper and lower winding shaft 1 and 2 during a poster change takes place in such a manner that a freely hanging constant poster loop forms in the region of the lower deflection device 4, independent of the winding direction. This constant loop is maintained the entire time during the winding process, by means of appropriately controlling the different speeds of rotation of the winding shafts 1 and 2, coordinated with one another. Only after the target position of the poster that is supposed to be displayed has been reached is the loop wound up by means of defined rewinding of one of the winding shafts 1 or 2. The poster is stretched tight by means of this rewinding.

In a preferred embodiment of the invention, the upper deflection device 3 and/or the lower deflection device 4 consists of a rotating shaft that is mounted in at least two ways. By means of the use of one or more rotating shafts, the poster is subject to less tensile stress at the deflection point. The friction becomes less, so that the required drive power for the winding shafts 1 and 2 can be reduced. As a result of the lower bending stress and tensile stress, the wear is less, and the lifetime of the poster web is increased, or cheaper material can be used for the production of the poster web.

In another embodiment, for reasons of space-saving construction, the looping angle of the poster at the deflection devices 3 and 4 is less than 270°. The most advantageous looping angle is 70 to 180°.

Starting from a certain width, the deflection devices 3 and 4 are supported on the housing frame 6 by means of supports 5, once or multiple times. This makes it possible, particularly in the case of large poster widths, to prevent any bending of the deflection device and to allow wrinkle-free unrolling or roll-up.

In order to be able to undertake a poster change without problems, it is advantageous to dispose the upper and/or the lower winding shaft 1 and/or 2 in exchangeable manner.

Since large-surface advertising devices for posters are known to require a relatively large amount of space at their set-up location, it is advantageous, in the case of individual locations, to provide a second poster changer in the same housing, practically back to back. This is possible if all the active individual parts such as winding shafts 1 and 2, deflection devices 3 and 4, supports 5, and drive and control devices 7 are disposed in duplicate. Then both sides are provided with a viewing pane, whereby the housing mount and the base frame 6 must be reinforced and dimensioned accordingly.

In a special embodiment, the lower winding shaft 2 is easily replaceable, so that during a poster replacement, the entire lower winding shaft 2 with the poster web already wound up on it can be replaced. In another special embodiment, the lower winding shaft 2 is disposed in a changing magazine, multiple times. In this connection, the magazine is configured in such a manner that by means of a type of indexing magazine, a different lower winding shaft 2 can quickly be brought into the working plane, by pivoting it, as needed, whereby then, all that is needed is to make the connection to the other upper winding shaft 1. The advantage is that several different poster webs can be brought into engagement, as needed, quickly, inexpensively, and without a lot of effort, using the same equipment. The opposite solution, that the upper winding shaft 1 is disposed in a changing magazine multiple times, can also be implemented.

In the case of a very wide poster web, for example in the case of widths greater than 10 meters, it is advantageous if counter-elements that act in slanted manner are disposed on the upper and/or lower deflection device 3 and/or 4. These counter-elements, which can consist of rollers that are disposed at a slant and act towards the left or the right, respectively (axis of rotation is at an angle to the center axis of the deflection device, in each instance), press against the upper and/or the lower deflection device 3 and/or 4. They act in the manner of width spreaders and can be disposed multiple times per deflection device 3 and/or 4.

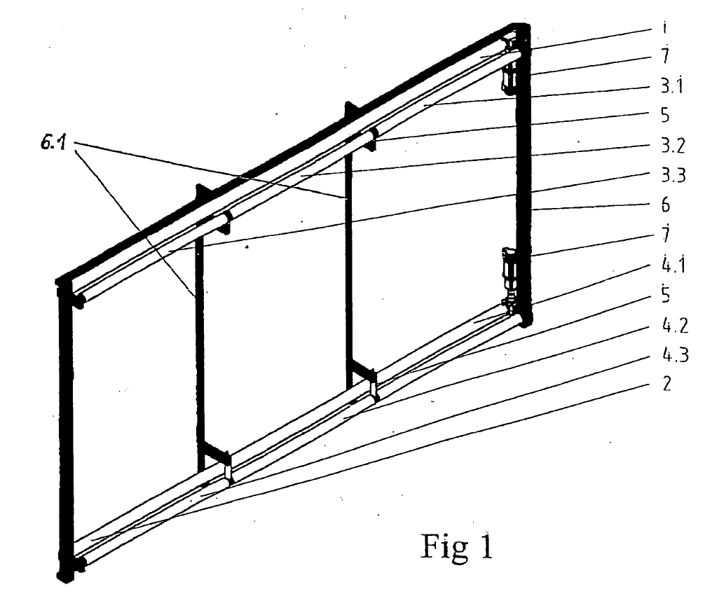

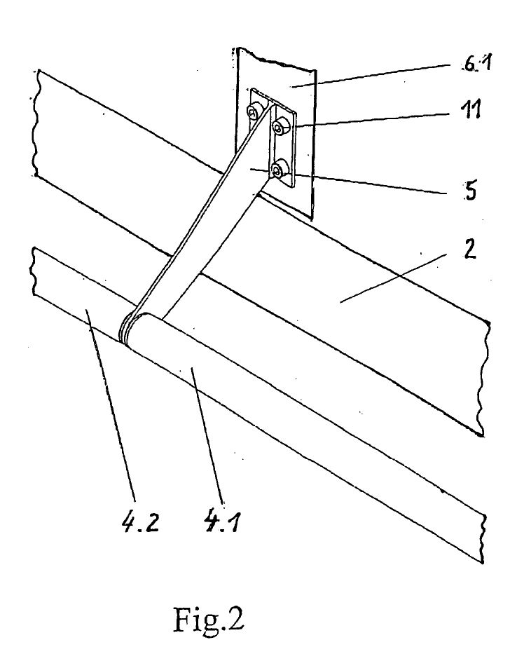

The invention will be explained in greater detail below, using FIGS. 1 and 2, which show a preferred exemplary embodiment.

FIG. 1. shows a schematic arrangement of the basic components of a large surface advertising device according to the invention,

FIG. 2 shows a detail as to how the lower deflection device 4 is supported to prevent bending, by means of a support 5.

The housing mount and base frame 6 are disposed in the interior of a housing of a large-surface advertising device according to the invention, not shown in FIG. 1. This housing mount and base frame 6 is configured in such a manner that it possesses the necessary rigidity and mechanical strength so as to support both the waterproof housing including the viewing pane, as well as the active individual parts according to the invention, for changing posters. Furthermore, one or more feet (not shown) are disposed in the lower region, which pass the static load (weight of the entire large-surface advertising device) and also the dynamic load (changing wind stresses) into the necessary foundation or, in accordance with the size of the entire large-surface advertising device, into foundation parts that are dimensioned accordingly.

The upper winding shaft 1 is disposed on the housing mount and base frame 6, which consists of an upper and a Lower crossbeam and a left and a right vertical support, in each instance, in the upper region. The drive and control device 7 is coupled to the upper winding shaft 1, by way of suitable means, such as spur wheels, for example. In the present exemplary embodiment, this upper drive and control device 7 is attached to the right vertical support. The drive and control device 7 for the lower shaft 2 also consists of a program-controlled servo-drive. The length of the upper and lower winding shaft 1 determines the possible width of the posters to be displayed. In the direction towards the observer, an upper deflection device 3 is disposed in front of the upper winding shaft 1, on the same shaft holder. This upper deflection device 3 is supported at two locations, by means of supports 5, on vertical intermediate supports 6.1. These vertical intermediate supports 6.1, which connect the upper and lower crossbeams, furthermore increase the rigidity of the housing mount and base frame 6. In the preferred exemplary embodiment, the upper deflection device 3 is therefore divided into three parts. This right, middle, and left upper deflection device are structured as mounted deflection rollers 3.1, 3.2, 3.3 here. By means of the two supports 5, bending of the entire deflection device 3 over its entire length is prevented. The mounted deflection rollers 3.1, 3.2, and 3.3 have the advantage that during the winding process of the poster web, when it is being wound onto the upper winding roller 1, less drive power from the drive and control device is required. The winding shafts 1 and 2 can therefore be produced inexpensively from simple and light materials, such as aluminum, for example. In the region of the lower crossbeam, the lower winding roller 2 is disposed on a shaft carrier in the same length as the upper winding shaft 1. It is also driven in program-controlled manner, by way of a drive and control unit 6 disposed on the right crossbeam, independent of the upper winding shaft. The lower deflection device 4 is also divided into three parts and supported on the vertical intermediate supports 6.1 by means of supports 5. In the exemplary embodiment, it consists of the right, center, and left lower deflection roller 4.1, 4.2, and 4.3, which are mounted to rotate.

A carrier web is attached to the upper winding shaft 1. The former is so long that the poster web, which consists of four posters that show different advertising images and are joined together, can be attached without problems. As a rule, the carrier web reaches down to the level of the lower winding shaft 2. There are different attachment possibilities between the carrier web and the poster web, which will not be described in detail here. Then the poster web, which has been delivered wound up onto a separate transport roller, is wound onto the upper winding shaft. The end of the poster web is then connected with the lower winding shaft 2, with a positive lock. The poster web is adjusted and tensioned by rotating one or both winding shafts 1 and 2.

A different advertising motif is displayed as follows. First, the upper winding shaft 1 is unwound to such an extent that a loosely hanging loop having specific dimensions forms in the region of the lower deflection device 3. This loop is not allowed to be too large or too small. Then, the lower winding shaft is turned on and as the poster web is further wound off the upper winding shaft 1, the lower winding shaft 2 is driven in such a manner that the loop remains constant. By means of this bias-free unwinding and winding up, the poster web is wound onto the lower winding shaft 2 without wrinkles. When a defined location has been reached, i.e. at the moment when the next advertising motif has completely the same coverage as the viewing pane surface, the rotational movement of the upper winding shaft 1 is stopped. Then the loop is further wound up by means of corresponding rotation of the lower winding shaft 2, until the poster has been stretched tight and the lower winding shaft 2 locks in place with an adjustable, defined bias.

The reverse process proceeds as follows. First, the poster web is unwound from the lower winding shaft 2 to such an extent that once again, the corresponding loop is formed in the region of the lower deflection device 4. Then the upper winding shaft 1 begins to roll up the poster web, without bias. In this connection, the poster web runs over the upper deflection rollers 3.1, 3.2, and 3.3, which also rotate. Since these deflection rollers 3.1, 3.2, and 3.3 are supported by means of supports 5, no bending is present in their region. Surprisingly, no wrinkle formation takes place during winding onto the upper winding shaft 1, despite the bending of the upper winding shaft 1 that is present. The same effect also occurs when the poster web is wound onto the lower winding shaft 2. Although the upper and lower winding shaft 1 and 2 are configured to be very long, and corresponding bending of the winding shafts is present at this great length, a repeated, wrinkle-free, destruction-free poster change with high poster change cycles and great poster web advancement speeds during the poster change is possible, by means of the large-surface advertising device for posters, according to the invention, and the method for controlling the poster change, according to the invention.

FIG. 2 shows a possible embodiment of a support 5 according to the invention, for supporting the right lower deflection roller 4.1 and the center lower deflection roller 4.2, in a detail. Behind that, the lower winding roller 2 is shown, onto which the poster web is wound. The support 5 is attached, by means of attachment elements 11, to the right vertical intermediate support 6.1, which in turn is rigidly connected with the lower crossbeam (not shown in the drawing).

In the right-angle supporting configuration of the lower supports 5 for the lower deflection device 4 according to FIG. 1, the transport roller with the poster web wound onto it can be laid down onto the horizontal shank during poster replacement. In a preferred form, two rotating rollers disposed in V shape are disposed per shank, so that the transport roller can rotate during unwinding, and the poster web is not damaged after being coupled to the support web, when the poster is first rolled onto the upper winding shaft 1.

### LIST OF REFERENCE SYMBOLS USED

1 upper winding shaft
2 lower winding shaft
3 upper deflection device
3.1 right upper deflection roller
3.2 center upper deflection roller
3.3 left upper deflection roller
4 lower deflection device
4.1 right lower deflection roller
4.2 center lower deflection roller
4.3 left lower deflection roller
5 support
6 housing mount and base frame
6.1 vertical intermediate support
7 drive and control device
11 attachment elements

1. Large-surface advertising device for posters, having a housing, in which supply rollers (winding shafts) to accommodate rollable posters in web form are disposed, particularly poster change devices for alternating advertising, whereby the housing is provided with a transparent viewing pane, and light sources are disposed behind or in front of the poster,
wherein
at least one upper and lower deflection device (3) and (4) is disposed on the housing mount and base frame (6), at the top and bottom, in each instance, in the region of the winding shafts (1) and (2), mounted in front.

2. Method for controlling the poster change by means of controlling the winding shafts (1) and (2),
wherein
the speeds of rotation of the upper and lower winding shaft (1) and (2) are controlled, as a function of their current diameter during the winding process, in such a manner
that a freely hanging constant poster loop forms during the poster change, independent of the winding direction,
and after the target position of the poster has been reached, the loop is wound up by means of defined rewinding of one of the upper or lower winding shaft (1) or (2), and the poster is tensed/stretched tight.

3. Large-surface advertising device for posters according to claim 1,
wherein
the upper deflection device (3) and/or the lower deflection device (4) consists of a shaft that is mounted in at least two locations.

4. Large-surface advertising device for posters according to claim 1,
wherein
the looping angle of the poster web at the upper and lower deflection device (3) and (4) is less than 270°.

5. Large-surface advertising device for posters according to claim 1,
wherein
the upper and lower deflection device (3) or (4) are supported once or multiple times on the housing mount and base frame (6), by means of supports (5).

6. Large-surface advertising device for posters according to claim 1,
wherein
the upper and lower winding shaft (1) and (2) are disposed to be replaceable.

7. Large-surface advertising device for posters according to claim 6,
wherein
the upper and/or lower winding shaft (1) and/or (2) are disposed multiple times in a changing magazine.

8. Large-surface advertising device for posters according to claim 1,
wherein
counter-elements that act at a slant are disposed on the upper and/or lower deflection device (3) and/or (4).

9. Large-surface advertising device for posters according to claim 1,
wherein
all the individual parts for poster holding and poster change are disposed in duplicate.
